(19) United States
(12) Patent Application Publication
(10) Pub. No.: US 2008/0024026 A1
(43) Pub. Date: Jan. 31, 2008

(54) Motor

(76) Inventors: Tomohiro Aoyama, Kosai-shi (JP); Yasuhide Ito, Hamamatsu-shi (JP)

Correspondence Address: PEARL COHEN ZEDEK LATZER, LLP, 1500 BROADWAY 12TH FLOOR, NEW YORK, NY, 10036, US

(21) Appl. No.: 11/878,699

(22) Filed: Jul. 26, 2007

(30) Foreign Application Priority Data
Jul. 28, 2006 (JP) 2006-206973

(51) Int. Cl. H02K 21/28

(52) U.S. Cl. 310/154.01

(57) ABSTRACT

A motor includes an annular armature core, a cylindrical yoke, and a permanent magnet that is fixed to the yoke in such a manner as to face the armature core in the radial direction. A plate-like magnetism guiding portion is located between the armature core and the permanent magnet. The magnetism guiding portion is made of a soft magnetic material, and has a first surface facing the permanent magnet and a second surface facing the armature core. With respect to the axial direction of the motor, the length of the first surface is equal to that of the permanent magnet, and the length of the second surface is less than that of the first surface With respect to the axial direction of the motor, the length of the permanent magnet is greater than that of the armature core.

### CROSS REFERENCE TO RELATED APPLICATIONS

This application claims priority to Japanese Patent Application 2006-206973, filed on Jul. 28, 2006, which is hereby incorporated in its entirety by reference

### BACKGROUND OF THE INVENTION

The present invention relates to a motor having a permanent magnet and an armature core, which faces the permanent magnets with respect to the radial direction

Japanese Laid-Open Patent Publication No. 2004-140950 discloses a motor that has a magnetic converging portion at the distal end of each tooth of an armature core, about which a coil is wound, to obtain a generate a high torque. The magnetism converging portion is integrally formed with the distal end of each tooth that radially extends from the armature core. With respect to the axial direction of the armature core, the dimension of the magnetism converging portion is greater than the dimension of the body of the tooth, and substantially equal to the dimension of a permanent magnet that faces the magnetism converging portion along the radial direction. This allows magnetic flux of the permanent magnets to be efficiently introduced into the teeth, which generates a high torque.

As described above, since the dimension of the magnetism converging portion is greater than that of the body of the tooth with respect to the axial direction of the armature core, the magnetism converging portion protrudes in the axial direction of the armature core at the distal end of the tooth. Therefore, an armature core with such teeth has a complicated shape The armature core of a complicated shape can be formed by compressing and sintering magnetic powder. However, such forming process requires advanced techniques, and thus increases the manufacturing costs.

To avoid such complications, an armature core may be formed by laminating core sheets that have been formed by punching conductive plates, and swaging the laminated core sheets in the direction of lamination. In this case, a portion of each magnetism converging portion that protrudes from the tooth body in the axial direction (hereinafter; referred to as a protruding portion) is formed by laminating core sheets that have shapes different from the core sheets for forming a portion of the armature core except the protruding portion (hereinafter, referred to as a core main body). The protruding portion is fixed to the core main body. However, it is troublesome to fix the protruding portion made of the laminated core sheets to the distal end of the tooth main body, and the manufacture of the armature cores is thus complicated.

### SUMMARY OF THE INVENTION

Accordingly, it is an objective of the present invention to provide a simply constructed motor that efficiently utilizes magnetic flux of a permanent magnet

To achieve the foregoing objective and in accordance with one aspect of the present invention, a motor including an annular armature core, a cylindrical yoke, a permanent magnet, and a plate-like magnetism guiding portion is provided. The permanent magnet is fixed to the yoke in such a manner as to face the armature core in a radial direction. With respect to the axial direction of the motor, a length of the magnet is greater than that of the armature core. The plate-like magnetism guiding portion is located between the armature core and the permanent magnet. The magnetism guiding portion is made of a soft magnetic material, and has a first surface facing the permanent magnet and a second surface facing the armature core. With respect to the axial direction of the motor, a length of the first surface is equal to that of the permanent magnet, and a length of the second surface is less than that of the first surface.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view illustrating a direct-current motor according to a first embodiment of the present invention, taken along a direction perpendicular to the axis of the motor;

FIG. 2 is a cross-sectional view taken along the axial direction of the motor shown in FIG. 1;

FIG. 3 is a plan view showing a short-circuit member assembly in the motor shown in FIG. 1;

FIG. 4A is a development view showing an electrical construction of the motor shown in FIG. 1;

FIG. 4B is a circuit diagram showing coils of an armature of the motor shown in FIG. 1;

FIG. 5 is an enlarged partial cross-sectional view illustrating the motor shown in FIG. 1;

FIG. 6A is a diagram showing the flow of magnetic flux in the motor shown in FIG. 1;

FIG. 6B is a diagram showing the flow of magnetic flux in a direct-current motor having no magnetism guiding portion;

FIGS. 7A and 7B are diagrams showing the operation of the magnetism guiding portion when an inverse magnetic field is applied to the motor shown in FIG. 1;

FIG. 8 is an enlarged partial cross-sectional view showing a direct-current motor according to a second embodiment of the present invention;

FIG. 9 is a perspective view showing an armature core in the motor shown in FIG. 8;

FIG. 10 is an exploded perspective view showing the armature core of FIG. 9 and an insulator;

FIG. 11 is an enlarged partial cross-sectional view showing a direct-current motor according to another embodiment of the present invention; and

FIG. 12 is an enlarged partial cross-sectional view showing a direct-current motor according to another embodiment of the present invention.

### DETAILED DESCRIPTION OF THE PREFERRED EMBODIMENT

A first embodiment of the present invention will now be described with reference to the drawings.

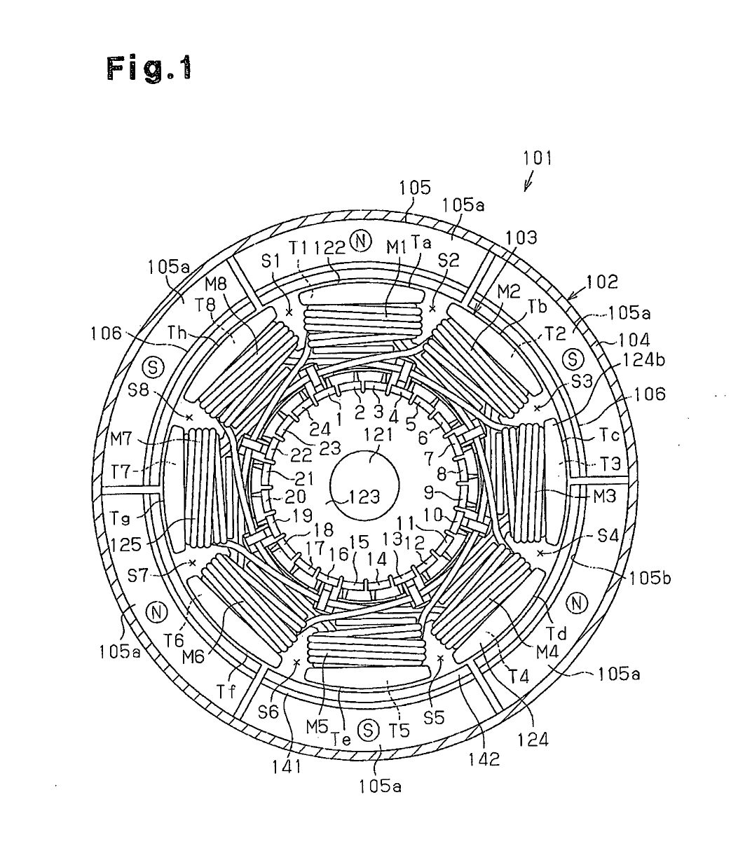

As shown in FIG. 1, a direct-current motor (hereinafter; referred to as a motor) 101 includes a stator 102 and an armature 103 located in the stator 102.

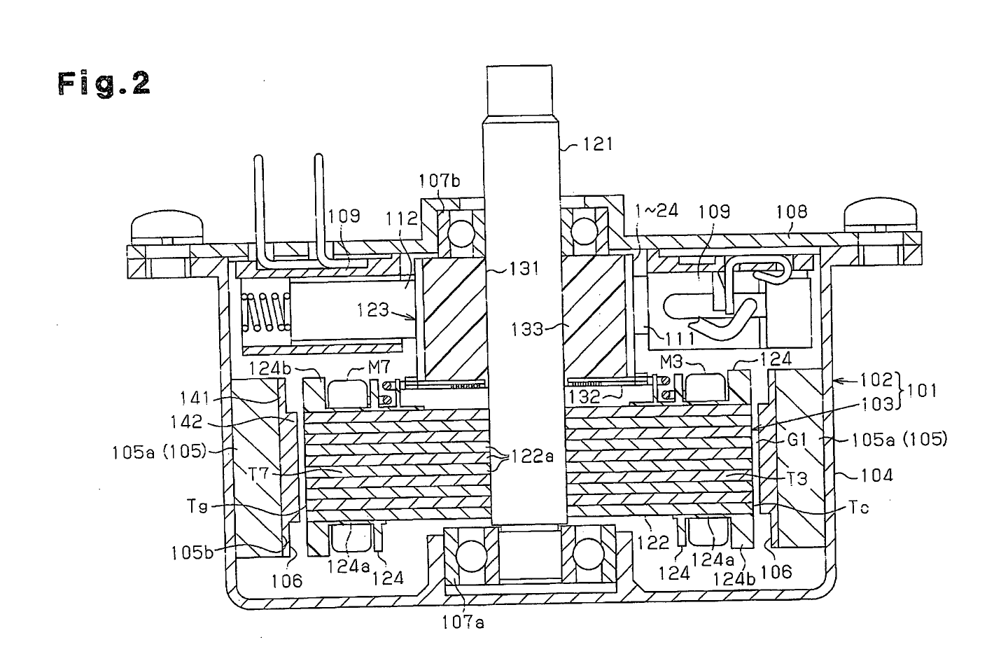

As shown in FIG. 2, the stator 102 has a yoke housing 104 shaped like a cylinder with a closed end. A permanent magnet 105 is fixed to the inner circumferential surface of the yoke housing 104. The permanent magnet 105 includes six magnet segments 105a separated along the circumferential direction as shown in FIG. 1. Each magnet segment 105a has a magnetic pole on a side facing the armature 103. The magnet segments 105a are arranged such that each circumferentially adjacent pair of the magnet segments 105a have different magnetic poles. That is, the number of the magnetic poles of the stator 102 is six. A magnetism guiding portion 106 is fixed to the radially inner surface of each magnet segment 105a

A bearing 107a is fixed to a center of the bottom of the yoke housing 104. The opening of the yoke housing 104 is closed by a disk-shaped end flame 108. A bearing 107b, which forms a pair with the bearing 107a, is fixed to a center of the end flame 108. A pair of brush holders 109 are fixed to a side of the end frame 108 that faces the yoke housing 104. The brush holders 109 are shaped like rectangular tubes extending in radial directions, and are spaced from each other by 180° along the circumferential direction. An anode brush 111 is accommodated in one of the brush holders 109, and a cathode brush 112 is accommodated in the other brush holder 109. The anode brush 111 and the cathode brush 112 are connected to an external power supply device (not shown).

The armature 103, which is surrounded by the magnet segments 105a, has a rotary shaft 121 rotatably supported by the bearings 107a, 107b. The armature 103 also has an armature core 122, a commutator 123, and coils M1 to M8 (see FIG. 1). The armature core 122 and the commutator 123 are fixed to the rotary shaft 121, and the coils M1 to M8 are wound about the armature core 122.

As shown in FIG. 1, the armature core 122 has eight teeth T1 to T8 extending radially from the rotary shaft 121. A slot is defined between each adjacent pair of the teeth T1 to T8. As shown in FIG. 2, with respect to the axial direction of the armature core 122, the dimension of the teeth T1 to T8 (only the teeth T3 and T7 are shown in FIG. 2) is less than that of the magnet segments 105a. In other words, with respect to the axial direction of the armature core 122, the dimension of the permanent magnet 105 is greater than that of the teeth T1 to T8.

The armature core 122 is formed by laminating core sheets 122a, which are made by pressing conductive plates, and swaging the laminated core sheets 122a in the direction of lamination The thickness of each core sheet 122a (the axial dimension of the armature 103) is constant at any point. In the state where the armature core 122 is fixed to the rotary shaft 121, distal surfaces Ta to Th (see FIG. 1) of the teeth T1 to T8 face the magnetism guiding portions 106 along the radial direction. Specifically, with respect to the axial direction of the armature 103, the center of the distal surface Ta to Th (opposed surfaces) of each of the teeth T1 to T8 agrees with the center of the corresponding magnet segment 105a and the center of the corresponding magnetism guiding portion 106.

As shown in FIG. 2, a pair of insulators 124 made of insulating synthetic resin are attached to both sides in the axial direction of each of the teeth T1 to T8. The insulators 124 cover the sections other than the inner circumferential surface and the outer circumferential surface of the armature core 122. The outer circumferential surface of the armature core 122 corresponds to the distal surfaces Ta to Th of the teeth T1 to T8 as shown in FIG. 1. Each insulator 124 has a covering portion 124a for covering one end face in the axial direction of the corresponding one of the teeth T1 to T8, and a blocking wall 124b that extends from a section closet to the magnet segment 105a, or from a radially outer end of the covering portion 124a. In the state where a pair of the insulators 124 are attached to each of the teeth T1 to T8, the distance from the distal end of the blocking wall 124b of one of the pair of the insulators 124 to the distal end of the blocking wall 124b of the other insulator 124 is equal to the axial length of the magnet segments 105a. A wire 125 is wound about the teeth T1 to T8 over the insulators 124 by way of concentrated winding. As a result, the armature core 122 has the eight coils M1 to M8 (see FIG. 1).

The commutator 123 has a commutator body 131 fixed to the rotary shaft 121 and a short-circuit member assembly 132 located at one end of the commutator body 131 in the axial direction. The commutator body 131 has a cylindrical insulating body 133 fixed to the rotary shaft 121, and twenty four segments 1 to 24, which are fixed to the outer-circumferential surface of the insulating body 133. The segments 1 to 24 are arranged at equal angular intervals along the circumferential direction. The anode brush 111 or the cathode brush 112 is pressed radially inward and contacts the segments 1 to 24.

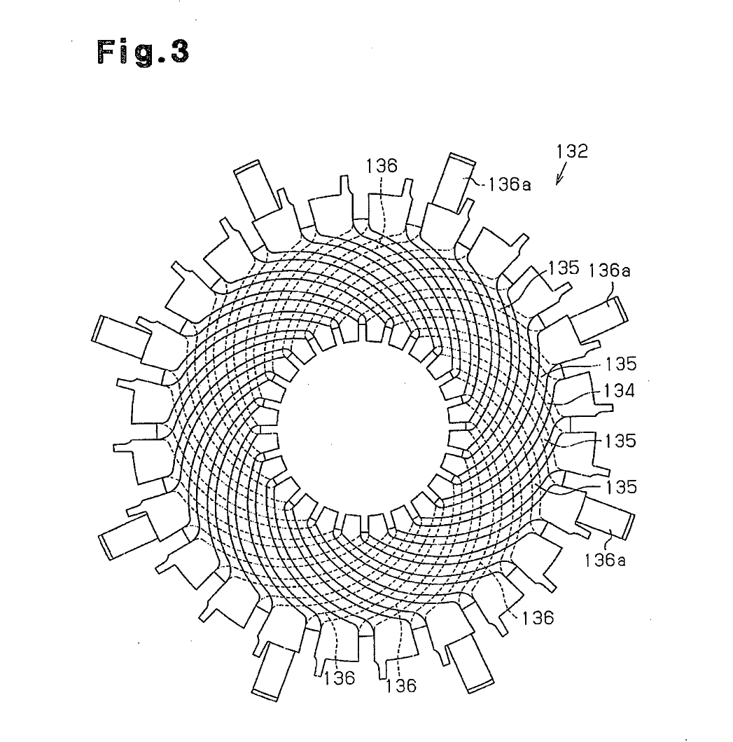

The short-circuit member assembly 132 is fixed to one end of the commutator body 131 that faces the armature core 122. As shown in FIG. 3, the short-circuit member assembly 132 has a first group of short-circuit segments and a second group of short-circuit segments, which are arranged on opposite sides of an insulation layer (a sheet of insulating paper) 134. The short-circuit segment groups each include twenty-four short-circuit segments 135, 136 arranged along the circumferential direction of the rotary shaft 121. In the fast short-circuit segment group (short-circuit segment group located toward the front of the sheet of FIG. 3), the radially inner end of each first short-circuit segment 135 is displaced from the radially outer end of the first Short-circuit segment 135 in one circumferential direction (clockwise direction as viewed in FIG. 3) by 60′. In the second short-circuit segment group (the short-circuit segment group located toward the back of the sheet of FIG. 3, and shown in broken lines), the radially inner end of each second short-circuit segment 136 is displaced from the radially outer end of the second short-circuit segment 136 in one circumferential direction (counterclockwise direction as viewed in FIG. 3) by 60°. The radially inner end of each first short-circuit segment 135 is electrically connected to the radially inner end of one of the second short-circuit segments 136, and the radially outer end of each first short-circuit segment 135 is electrically connected to the radially outer end of one of the second short-circuit segments 136. Accordingly, the radially outer ends of each set of three of the first short-circuit segments 135 that are arranged at intervals of 120° are electrically connected, and the radially outer ends of each set of three of the second short-circuit segments 136 that are arranged at intervals of 120° are electrically connected.

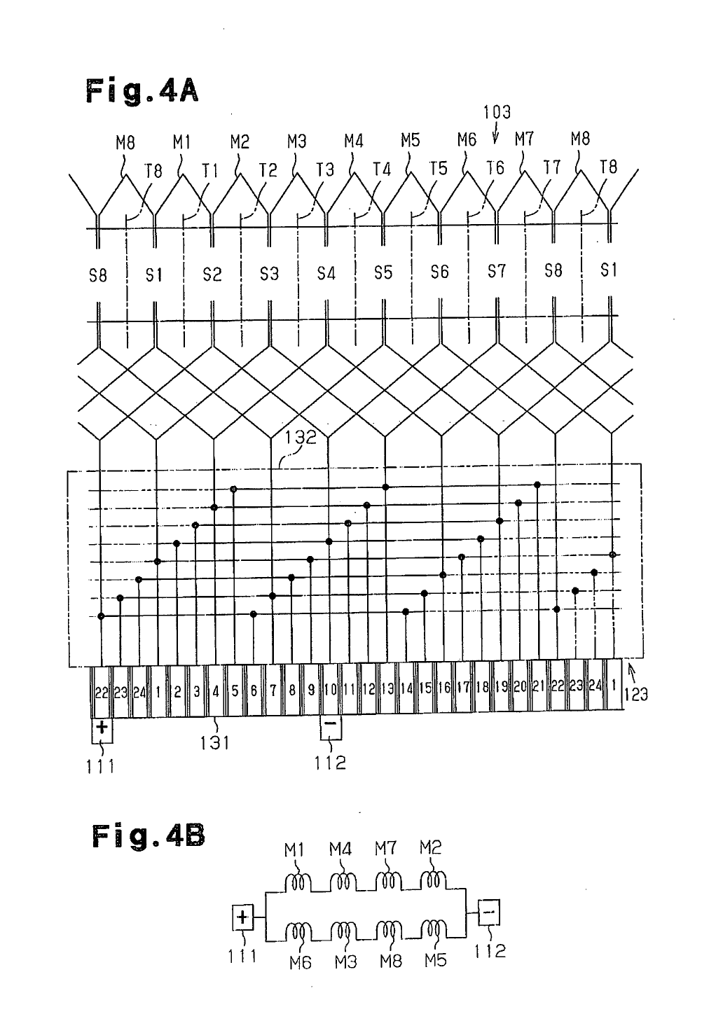

The short-circuit member assembly 132 is fixed to the comnmutator body 131 such that the radially outer end of each of the first and second short-circuit segments 135, 136 is electrically connected to the corresponding one of the segments 1 to 24 Accordingly, out of the twenty-four segments 1 to 24, each set of three segments that are arranged at intervals of 120° are electrically connected to one another as shown in FIG. 4A. For example, the short-circuit member assembly 132 short-circuits the three segments 1, 9, and 17 with one another so that the segments 1, 9, and 17 are at the same potential, and short-circuits the three segments 5, 13, and 21 so that the segments 5, 13, and 21 are at the same potential.

As shown in FIG. 3, out of the twenty-four second short-circuit segments 136, risers 136a are provided at the radially outer ends of eight second short-circuit segments 136 arranged at intervals of 45°. The ends of the corresponding coils M1 to M8 (see FIG. 1) are connected to and fixed to the risers 136a. That is, the number of the risers 136a is eight in total. As shown in FIG. 4A, the coils M1 to M8 connected to the segments 1 to 24 by engaging the ends of the coils M1 to M8 with the risers 136a (see FIG. 3), and form a single closed loop. That is, the coils M1 to M8 are connected in series. As shown in FIG. 4B, the coils M1 to M8 are connected in series in the order of M1, M4, M7, M2, M5, M8, M3, M6, and M1 to form a closed loop. FIG. 4B is a diagram representing the circuit formed by the coils M1 to M8 in FIG. 4A in a visually easy-to-understand form.

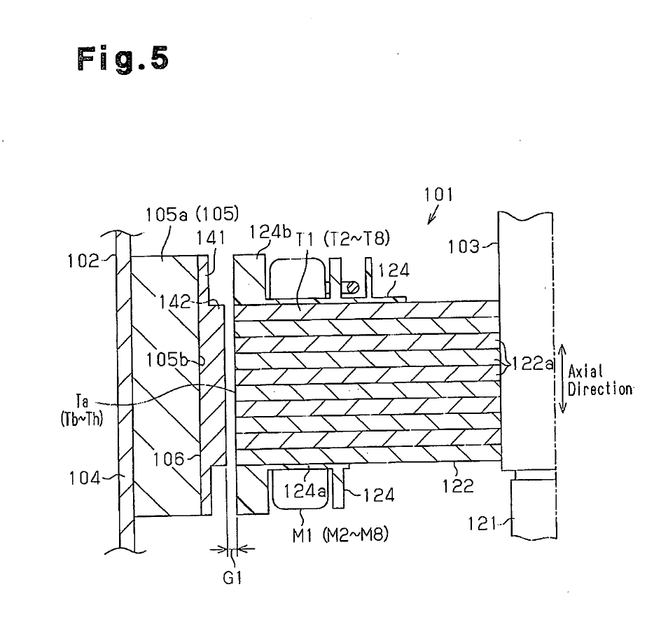

Next, the magnetism guiding portions 106 will be described. In the following, although only one of the magnetism guiding portions 106 and the associated components are discussed as necessary with reference to the drawings, the explained configuration is applicable to all the magnetism guiding portions 106 and the associated components. For example, the explanations regarding the tooth T1 and its distal surface Ta are applied to the remainders of the teeth T2 to T8 and the distal surfaces Th to Th. As shown in FIG. 5, the magnetism guiding portion 106 has a plate-like first guiding portion 141 fixed to a radially inner surface of the corresponding magnet segment 105a, or a surface 105b that faces the armature core 122, and a plate-like second guiding portion 142 that protrudes from the first guiding portion 141 toward the armature core 122. The second guiding portion 142 is located at a center of the first guiding portion 141 with respect to the axial direction of the stator 102. The magnetism guiding portion 106 is made of soft magnetic material. For example, the magnetism guiding portion 106 is formed by compression molding powder of soft magnetic material.

The first guiding portion 141 has a size that is equal to the radially inner surface 105b of the magnet segment 105a, and is fixed to the magnet segment 105a to entirely cover the radially inner surface 105b. With respect to the axial direction of the stator 102, the dimension of the second guiding portion 142 (the axial length) is equal to that of the distal surfaces Ta to Th of the teeth T1 to T8. The circumferential width of the second guiding portion 142 is equal to the circumferential width of the first guiding portion 141. As shown in FIG. 1, the first guiding portion 141 is curved along the radially inner surface 105b of the magnet segment 105a, and the second guiding portion 142 is curved along the first guiding portion 141. In the state where the armature core 122 is fixed to the rotary shaft 121, which is rotatably supported by the bearings 107a, 107b (see FIG. 2), the second guiding portion 142 faces the distal surface Ta of the tooth T1 along the radial direction with an air gap G1 in between.

In the direct-current motor 101 constructed as above, when an electric current is supplied to the coils M1 to M8 from the external power supply device through the anode brush 111 and the cathode brush 112, the coils M1 to M8 generate a magnetic field, which rotate the armature 103. The rotation of the armature 103 causes the commutator 123 to rotate. Accordingly, the anode brush 111 and the cathode brush 112, which sequentially slide on the segments 1 to 24, perform rectification

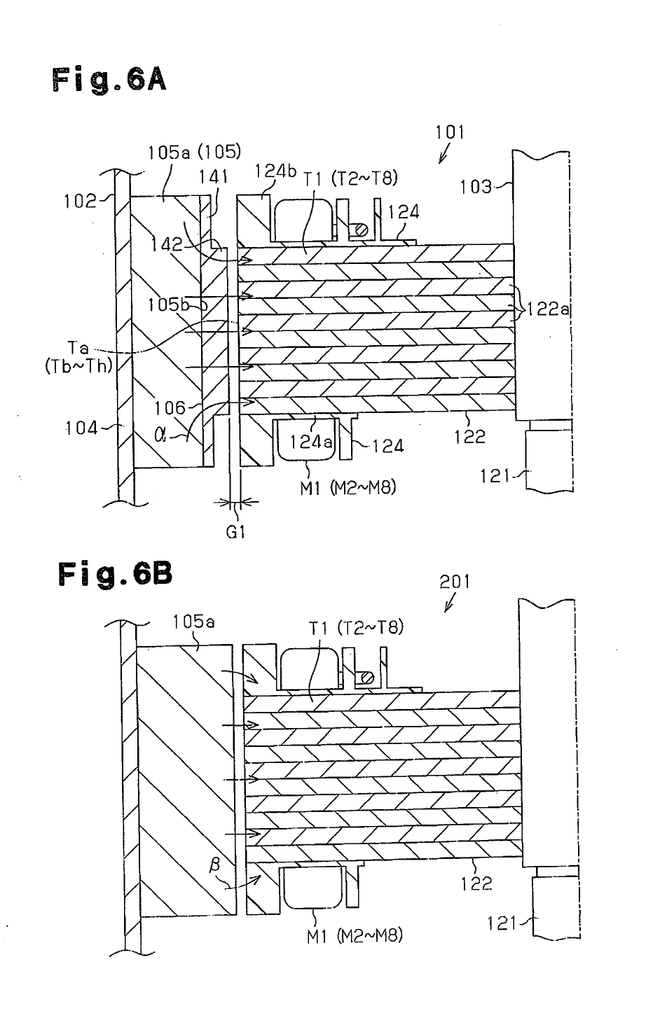

At this time, as shown in FIG. 6A, the magnetic flux of the magnet segment 105a flows from the first guiding portion 141 to the tooth T1 through the second guiding portion 142 as indicated by arrows ac. In the magnet segment 105a, the magnetic flux from a portion that protrudes further in the axial direction than the armature core 122 flows from the first guiding portion 141 to the tooth T1 through the second guiding portion 142. Therefore, the magnetic flux of the magnet segment 105a flows into the tooth T1 through between the second guiding portion 142 and the distal surface Ta of the tooth T1, which is the narrowest portion between the armature core 122 and the magnetism guiding portion 106.

In contrast, a direct-current motor 201 shown in FIG. 6B has magnet segments 105a, the axial length of which is longer than that of the teeth T1 to T8, but does not have the magnetism guiding portions 106 of the present embodiment. In the direct-current motor 201, the distance between the tooth T1 and a portion of the magnet segment 105a that protrudes further in the axial direction than the tooth T1 is extended, which increases the magnetic reluctance. As a result, the magnetic flux flowing through the tooth T1 is reduced in comparison with the motor 101 provided with the magnetism guiding portions 106. In FIG. 6B, the flow of magnetic flux through the magnet segment 105a is represented by arrows β.

As described above, even if the axial length of the magnet segment 105a is greater than that of the tooth T1, the magnetism guiding portion 106 of the illustrated embodiment efficiently guides the magnetic flux of the magnet segment 105a into the tooth T1.

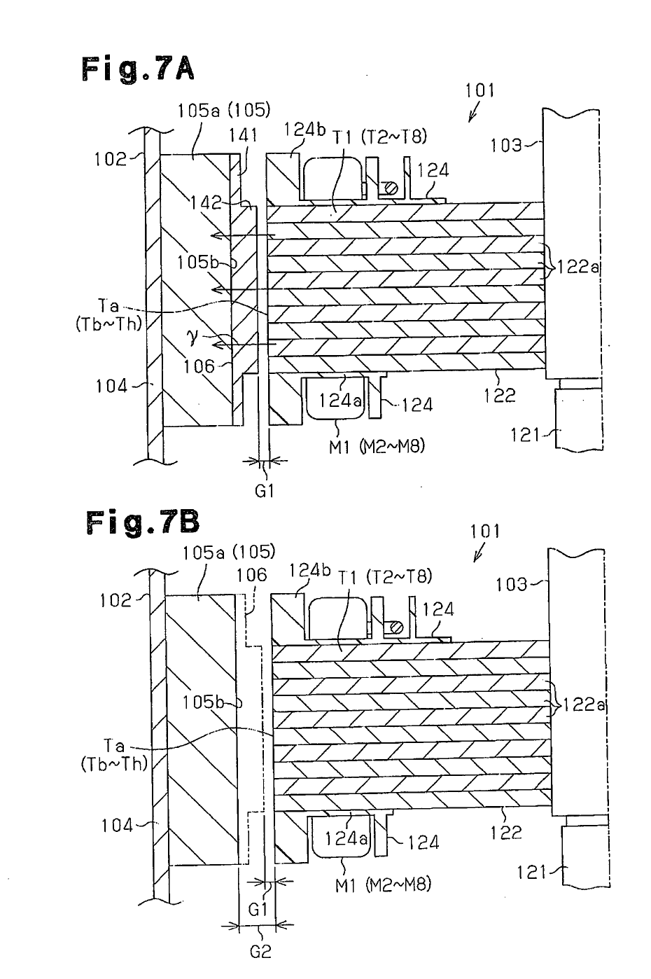

When an inverse magnetic field (represented by arrows γ in FIG. 7A) having a magnitude that demagnetizes the magnet segment 105a is applied to the armature 103 and the permanent magnet 105 as shown in FIG. 7A, the magnetism guiding portion 106 causes magnetic saturation, which increases the magnetic reluctance. Therefore, the state shown in FIG. 7A is equivalent to the state shown in FIG. 7B, in which an air gap G2 is provided between the magnet segment 105a and the tooth T1, the radial width of the air gap G2 being greater than that of the actual air gap G1 by the amount corresponding to the size of the magnetism guiding portion 106. Therefore, the magnetism guiding portion 106 suppresses the demagnetization of the magnet segment 105a.

The above illustrated embodiment has the following advantages.

(1) The magnetism guiding portion 106 made of a soft magnetic material is fixed to the radially inner surface 105b of the magnet segment 105a, and is located between the armature core 122 and the magnet segment 105a (the permanent magnet 105). Thus, the magnetic flux of the magnet segment 105a enters the tooth T1 through the magnetism guiding portion 106. The magnetism guiding portion 106 is shaped like a plate. The axial length of the first guiding portion 141 closer to the magnet segment 105a is equal to that of the magnet segment 105a. The axial length of the second guiding portion 142 closer to the armature core 122 is equal to that of the outer circumferential surface (that is, the distal surface Ta of the tooth T1) of the armature core 122. Therefore, since it passes through the magnetism guiding portion 106, the magnetic flux of the magnet segment 105a flows into the armature core 122 through a space between the second guiding portion 142 and the distal surface Ta of the tooth 11, or the shortest distance. That is, the magnetic flux flows into the armature core 122 through the air gap G1. Therefore, even if the permanent magnet 105 (the magnet segment 105a) is longer than the armature core 122 along the axial direction, the magnetic flux of the permanent magnet 105 is easily guided into the armature core 122 because the magnetic flux passes through the magnetism guiding portion 106. Thus, the magnetic flux of the permanent magnet 105 is efficiently utilized by simply providing the magnetism guiding portion 106 between the armature core 122 and the permanent magnet 105 (the magnet segment 105a).

(2) When an inverse magnetic field having a magnitude that demagnetizes the permanent magnet 105 is applied to the armature core 122 and the permanent magnet 105, the magnetism guiding portion 106 causes magnetic saturation, which increases the magnetic reluctance of the magnetism guiding portion 106. Thus, the demagnetization of the permanent magnet 105 is suppressed. As a result, the life of the direct-current motor 101 is extended.

(3) The magnetism guiding portions 106 are each provided for one of the magnet segments 105a. For example, if a single magnetism guiding portion is provided for each circumferentially adjacent pail of the magnet segments 105a, the magnetism guiding portion serves as a magnetism passage between the two magnet segments 105a and causes part of the magnetic flux of one of the magnet segment 105a to flow to other magnet segment 105a through the magnetism guiding portion. However, by providing one magnetism guiding portion 106 for each magnet segment 105a as in the illustrated embodiment, the magnetism guiding portion 106 is prevented from serving as a magnetism passage between the adjacent magnet segments 105a. Therefore, the reduction of the magnetic flux flowing to the armature core 122 is suppressed.

(4) Since the magnetism guiding portion 106 is fixed to the magnet segment 105a, the magnetism guiding portion 106 is easily installed. Also, since the magnetism guiding portion 106 is shaped like a plate, the magnetism guiding portion 106 is easily fixed to the magnet segment 105a.

(5) The magnetism guiding portion 106 is located between the armature core 122 and the permanent magnet 105. Thus, even if the permanent magnet 105 (the magnet segment 105a) is longer than the armature core 122 in the axial direction, the magnetic flux of the permanent magnet 105 is used efficiently. That is, a greater amount of magnetic flux is taken into the armature core 122 without increasing the axial length of the armature core 122 If the axial dimension of the armature core 122 is increased to increase the power of the direct-current motor, a great change of design is required. For example, the positions of the bearings 107a, 107b and the commutator 123, which are located on both sides of the armature core 122 in the axial direction, need to be changed. However, in the illustrated embodiment, the magnetism guiding portion 106 eliminates the necessity for increasing the axial dimension of the armature core 122. The power of the direct-current motor 101 can be increased without a great change of design.

A second embodiment of the present invention will now be described with reference to the drawings The differences from the first embodiment will mainly be discussed below.

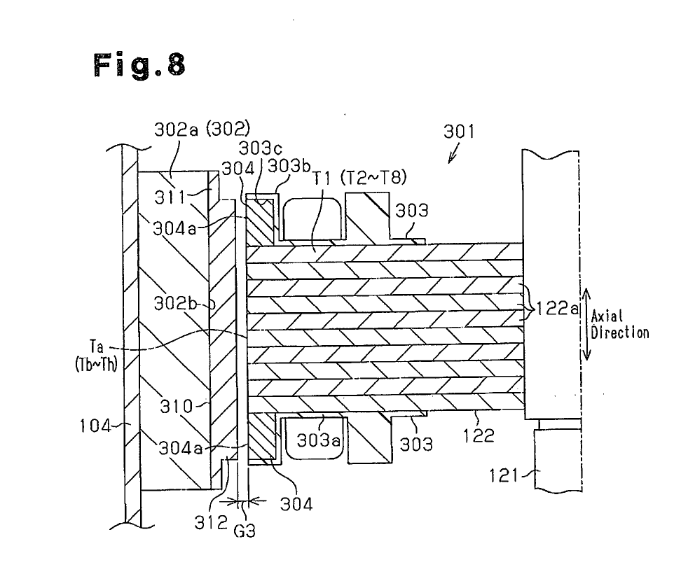

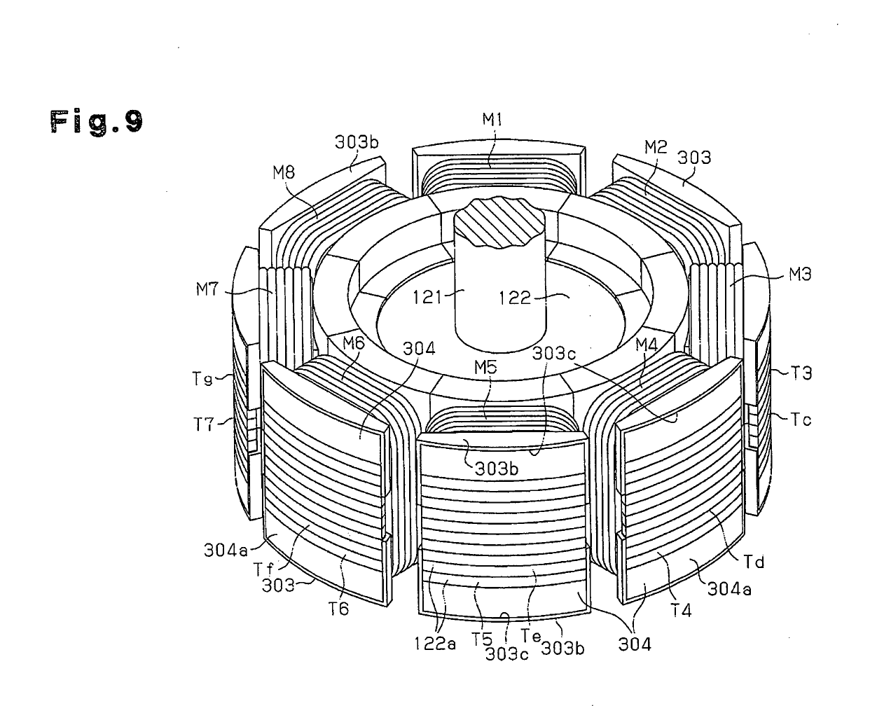

FIG. 8 shows a direct-current motor 301 according to the second embodiment. Although FIG. 8 only illustrates the tooth T1 and the coil M1, the other teeth T2 to T8 and the coils M2 to M8 have the same constructions as illustrated in FIG. 8.

As shown in FIG. 8, the motor 301 of this embodiment has a permanent magnet 302 and insulators 303, which are different from the permanent magnet 105 and the insulators 124 of the motor 101 of the first embodiment.

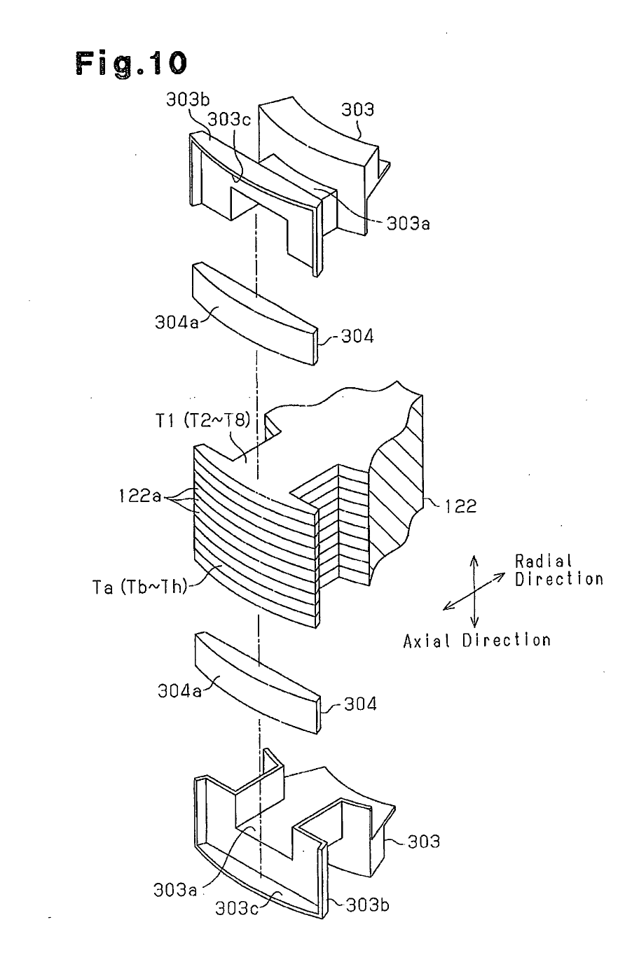

As shown in FIGS. 9 and 10, a pair of insulators 303 made of insulating synthetic resin are attached to both sides of each of the teeth T1 to T8 of the armature core 122 in the axial direction of the rotary shaft 121. The insulators 303 cover the sections other than the inner circumferential surface and the outer circumferential surface of the armature core 122. As shown in FIG. 10, each insulator 303 has a covering portion 303a for covering one end face in the axial direction of the corresponding one of the teeth T1 to 18, and a blocking wall 303b that extends from a section closer to the magnet segment 302a, or from a radially outer end of the coveting portion 303a (refer to FIG. 8). Each blocking wall 303b has an accommodation recess 303c that opens radially outward. An auxiliary core 304 is press fitted in the recess 303c The auxiliary core 304 is substantially shaped like a rectangular parallelepiped to correspond to the recess 303c. When the auxiliary core 304 is viewed in the axial direction of the rotary shaft 121, the position of a radially outer surface 304a in the radial direction agrees with the position of the distal surface Ta of the tooth T1 in the radial direction. That is, in the armature core 122, to which the insulators 303 are attached as shown in FIG. 9, the outer surface 304a of each auxiliary core 304 is in the same plane as the distal surfaces Ta to Th of the teeth T1 to T8. The auxiliary core 304 is formed by laminating and swaging auxiliary sheets, which are formed by punching steel plates (in FIGS. 8 to 10, the auxiliary sheets are not shown). A wire 125 is wound about the teeth T1 to T8 over the insulators 303 by way of concentrated winding. As a result, the armature core 122 has the eight coils M1 to M8

As shown in FIG. 8, each of the six magnet segments 302a has a magnetic pole on a side facing the armature 122 as in the first embodiment. The magnet segments 302a are fixed to the inner circumferential surface of the yoke housing 104 and arranged at equal angular intervals along the circumferential direction. In the state where a pair of the insulators 303 are attached to each of the teeth T1 to T8, the distance from the distal end of the blocking wall 303b of one of the pair of the insulators 303 to the distal end of the blocking wall 303b of the other insulator 303 is less than the axial length of the magnet segment 302a. Also, a magnetism guiding portion 310 like the magnetism guiding portion 106 of the first embodiment is fixed to a radially inner surface 302b of the magnet segment 302a.

The magnetism guiding portion 310 has a plate-like first guiding portion 311 fixed to a radially inner surface of the corresponding magnet segment 302a, or a surface 302b that faces the armature core 122, and a plate-like second guiding portion 312 that protrudes from the first guiding portion 311 toward the armature core 122 (radially inward). The magnetism guiding portion 310 is made of soft magnetic material. For example, the magnetism guiding portion 106 is formed by compression molding powder of soft magnetic material.

The first guiding portion 311 has a size that is equal to the radially inner surface 302b of the magnet segment 302a, and is fixed to the magnet segment 302a to entirely cover the radially inner surface 302b. The first guiding portion 311 is curved along the radially inner surface 302b of the magnet segment 302a. The axial length of the second guiding portion 312 is equal to the sum of the axial length of the distal surface Ta of the tooth T1 and the axial length of the outer surface 304a of two auxiliary cores 304 located at both axial ends of the tooth T1. The circumferential width of the second guiding portion 312 is equal to the circumferential width of the first guiding portion 311. The second guiding portion 312 is curved along the first guiding portion 311. In the state where the armature core 122 is fixed to the rotary shaft 121, which is rotatably supported by the bearings 107a, 107b (see FIG. 2), the second guiding portion 312 faces the distal surface Ta of the tooth T1 and the auxiliary cores 304 located at axial ends of the tooth T1 along the radial direction with an air gap G3 in between.

In the motor 301 constructed as above, the rotating magnetic field generated by the coils M1 to M8 causes the armature core 122 and the rotary shaft 121 to rotate. At this time, the magnetic flux from both ends of each magnet segment 302a heads for the interior of the tooth T1 after passing through the first guiding portion 311, the second guiding portion 312, and the auxiliary cores 304 Therefore, the magnetic flux of the magnet segments 302a is efficiently guided into the tooth T1.

In addition to the advantages (2) to (5) of the first embodiment, the second embodiment has the following advantage.

(6) The recess 303c open to the radially outward direction is formed in the blocking wall 303b of each of the insulators 303 attached to the armature core 122. By press fitting the auxiliary core 304 into each recess 303c, the auxiliary core 304 is easily arranged at a portion of the end face of the armature core 122 in the axial direction that is close to the magnet segment 302a. The auxiliary core 304 substantially increases the axial length of the outer circumferential portion of the armature core 122. Therefore, even if the axial length of the magnet segment 302a (the permanent magnet 302) is greater than that of the armature core 122, the magnetic flux of the permanent magnet 302 is efficiently guided into the armature core 122.

(7) The armature core 122 is capable of generating magnetic flux the magnitude of which is equivalent to the magnetic flux of an armature core having an axial length equal to the axial length of the armature core 122 having the auxiliary cores 304. Therefore, the axial length of the armature core 122 can be reduced without reducing the power of the motor 301, which reduces the weight of the direct-current motor 301

(8) In each magnetism guiding portion 310, the axial length of the first guiding portion 311 close to the magnet segment 302a is equal to that of the magnet segment 302a. In the magnetism guiding portion 310, the axial length of the second guiding portion 312, which is closer to the armature core 122, is equal to the sum of the axial length of the distal surface Ta of the tooth T1 and the axial length of the outer surface 304a of two auxiliary cores 304 located at both axial ends of the tooth T1. As a result, the magnetic flux of each magnet segment 302a flows into the armature core 122 through the air gap G3 by passing through the magnetism guiding portion 310 Therefore, even if the permanent magnet 302 (the magnet segment 302a) is longer than the armature core 122 along the axial direction, the magnetic flux of the permanent magnet 302 is easily guided into the armature cote 122 because the magnetic flux passes through the magnetism guiding portion 310. As a result, the magnetic flux of the permanent magnet 302 is efficiently utilized by simply providing the magnetism guiding portion 310 between the armature core 122 and the permanent magnet 302 (the magnet segment 302a)

(4) Each auxiliary core 304 is covered by the blocking wall 303b. Thus, when the coils M1 to M8 are wound about the armature core 122 to which the insulators 303 are attached, the coils M1 to M8 do not contact the auxiliary cores 304. As a result, the coils M1 to M8 are prevented from being damaged during the winding procedure

The preferred embodiments may be modified as follows.

In the second embodiment, as long as it is shorter than the axial length of the first guiding portion 311, the axial length of the second guiding portion 312 of the magnetism guiding portion 310 may be shorter or longer than the sum of the axial length of the distal surface Ta of the tooth T1 and the axial length of the outer surfaces 304a of the two auxiliary cores 304 located at both axial ends of the tooth T1.

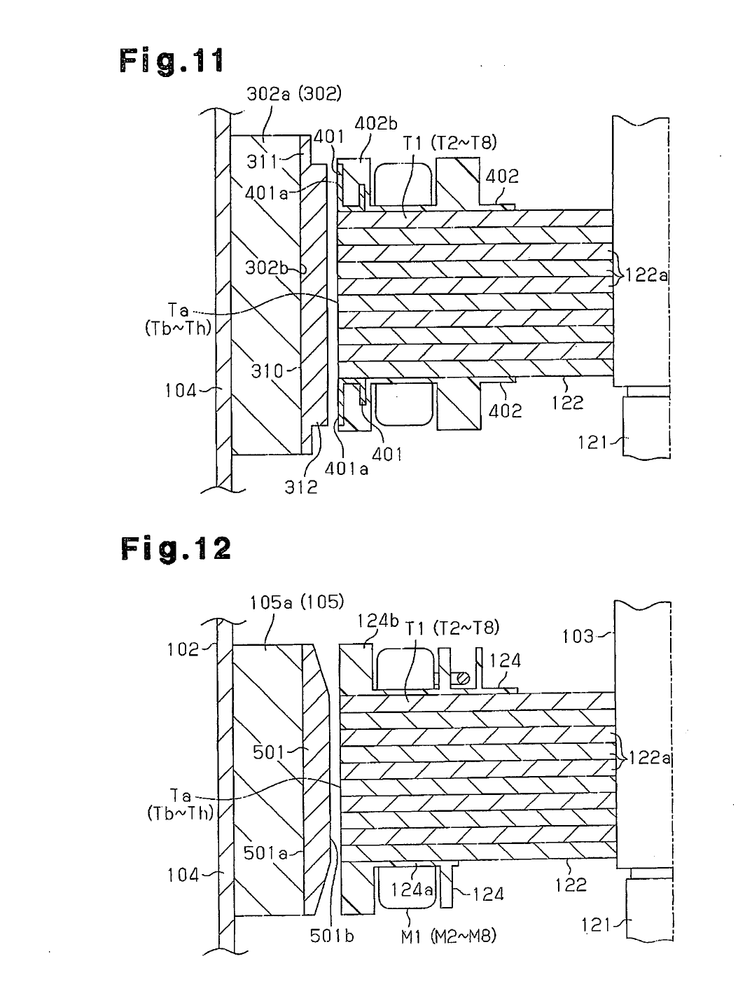

In the second embodiment, the auxiliary core 304 is press fitted in the accommodation recess 303c so as to be fixed to the insulator 303. However, as shown in FIG. 11, an auxiliary core 401 that is integrally formed with a blocking wall 402b of an insulator 402 may be used. The cross section of the auxiliary core 410 along the radial direction is shaped like a channel. In FIG. 11, the same reference numerals are given to those components that are the same as the corresponding components in the second embodiment. The auxiliary core 401 is integrated with the blocking wall 402b of the insulator 402 through the insert molding. An outer surface 401a of the auxiliary core 401 (that is, a surface facing the magnet segment 302a) is located in the same plane as the distal surface Ta of the tooth T1. Since the auxiliary core 401 is integrated with the blocking wall 402b, the auxiliary core 401 is easily installed in the armature core 122 at the same time as the insulator 402 is attached.

The cross-sectional shape of the auxiliary core 401 is not limited to a channel, but may be any shape as long as the auxiliary core 401 is integrated with the blocking wall 402b, and the outer surface 401a of the auxiliary core 401 is in the same plane as the distal surface Ta of the tooth T1. For example, the cross section of the auxiliary core 401 along the radial direction may be L-shaped.

In the second embodiment, the auxiliary core 304 is shaped as a rectangular parallelepiped. However, the auxiliary core 304 may have any shape as long as it can be press fitted to the accommodation recess 303c, and the outer surface 304a of the auxiliary core 304 is in the same plane as the distal surface Ta of the tooth T1. For example, the auxiliary core 304 along the radial direction may be shaped like a channel. In this case, the accommodation recess 303c has a shape corresponding to the auxiliary core 304 so that the auxiliary core 304 can be press fitted in the accommodation recess 303c.

In the second embodiment, the auxiliary core 304 may be formed of SMC material. In the first embodiment, as long as it is less than the axial length of the first guiding portion 141, the axial length of the second guiding portion 142 may be longer or shorter than the axial length of the outer circumferential surface of the armature core 122 (that is, the distal surface Ta of the tooth T1).

In the first embodiment, the magnetism guiding portion 106 may be modified as long as it is shaped like a plate in which the axial length of the side corresponding to the permanent magnet 105 is equal to that of the permanent magnet 105, and the axial length of the side corresponding to the armature core 122 is shorter than that of the side corresponding to the permanent magnet 105. For example, a magnetism guiding portion 501 shown in FIG. 12 is shaped in such a manner that the axial length of a side 501a corresponding to the permanent magnet 105 is equal to that of the permanent magnet 105, and is shortened toward the armature core 122. The axial length of a side 501b of the magnetism guiding portion 501 corresponding to the armature core 122 is equal to that of the outer circumferential surface of the armature core 122 (that is, the distal surface Ta of the tooth T1). This modification has the same advantages as the advantages (1) and (2) of the first embodiment. Likewise, the magnetism guiding portion 310 of the second embodiment may be shaped like a plate in which the axial length of a side corresponding to the permanent magnet 302 is equal to that of the permanent magnet 302, and the axial length of a side corresponding to the armature core 122 is shorter than that of the side corresponding to the permanent magnet 302.

The magnetism guiding portions 106, 310 are fixed to the magnet segments 105a, 302a, respectively, but may be fixed to the distal surfaces Ta to Th of the teeth T1 to T8, respectively. The magnetism guiding portion 106, 310 may be located between the magnet segments 105a, 302a and the armature core 122 without being fixed to the magnet segment 105a, 302a or the distal surfaces Ta to Th of the teeth T1 to T8.

A single magnetism guiding portion 106, 310 may be fixed to two or more magnet segments 105a, 302a.

The permanent magnet 105, 302 may be a cylindrical permanent magnet in which different polarities are alternately arranged along the circumference. In this case, a magnetism guiding portion may be fixed to the inner circumferential surface of the cylindrical permanent magnet. Alternatively, a number of magnetism guiding portion may be provided, with each fixed to one of the magnetic poles.

As long as it is made of a soft magnetic material, the magnetism guiding portion 106, 310 may be made, for example, of steel plates.

The number of magnetic poles, the number of coils, and the number of the segments of the motor 101, 301 may be changed arbitrarily. For example, the present invention may be applied to a motor in which the number of the magnetic poles P is four or more, the number of coils N is P±2 (when P=4, N=6), and the number of segments S is N(P/2).

In the motors 101, 301, the permanent magnet 105 fixed to the yoke housing 104 is located on the outer circumference of the armature core 122. This configuration may be changed. For example, the magnetism guiding portions 106, 310 may be provided for a motor in which permanent magnets are fixed to the inner surface of an armature core having teeth that extend radially inward, and a yoke fixed to a rotary shaft is located inside the armature core.

What is claimed is:

1. A motor comprising:
an annular at mature core;
a cylindrical yoke;
a permanent magnet that is fixed to the yoke in such a manner as to face the armature core in a radial direction, wherein, with respect to the axial direction of the motor, a length of the magnet is greater than that of the armature core; and
a plate-like magnetism guiding portion located between the armature core and the permanent magnet, the magnetism guiding portion being made of a soft magnetic material, and having a first surface facing the permanent magnet and a second surface facing the armature core, wherein, with respect to the axial direction of the motor, a length of the first surface is equal to that of the permanent magnet, and a length of the second surface is less than that of the first surface.

2. The motor according to claim 1, wherein the permanent magnet is separated along a circumferential direction of the yoke so as to include a plurality of magnet segments each having a magnetic pole on a side facing the second surface, wherein the magnet segments are arranged in such a manner that each circumferentially adjacent pair of the magnet segments have different magnetic poles, and wherein the magnetism guiding portion is one of a plurality of magnetism guiding portions each corresponding to one of the magnet segment.

3. The motor according to claim 1, wherein the magnetism guiding portion is fixed to the permanent magnet.

4. The motor according to claim 1, wherein, with respect to the axial direction of the motor, the length of the second surface is equal to that of a surface of the armature core that faces the magnetism guiding portion.

5. The motor according to claim 1, wherein the armature core includes a coil wound about the armature core, and an insulator for insulating the armature core from the coil,
wherein the insulator includes a covering portion and a blocking wall, the coveting portion coveting both end faces of the armature core in the axial direction, and the blocking wall extending from an end of the coveting portion that is closer to the permanent magnet, thereby preventing the coil projecting toward the permanent magnet, and
wherein the blocking wall includes an accommodation recess into which an auxiliary core is press fitted, the auxiliary core facing the magnetism guiding portion in the radial direction.

6. The motor according to claim 1, wherein the armature core includes a coil wound about the armature core, and an insulator for insulating the armature core from the coil,
wherein the insulator includes a covering portion and a blocking wall, the covering portion covering both end faces of the armature core in the axial direction, and the blocking wall extending from an end of the covering portion that is closer to the permanent magnet, thereby preventing the coil projecting toward the permanent magnet, and
wherein the blocking wall is integrated with an auxiliary cote through insert molding, the auxiliary core facing the magnetism guiding portion in the radial direction

7. The motor according to claim 5, wherein the auxiliary core has a side surface that faces the magnetism guiding portion, and wherein, with respect to the axial direction of the motor, the length of the second surface of the magnetism guiding portion is equal to the sum of a length of a surface of the armature core that faces the magnetism guiding portion and a length of the side surface of the auxiliary core, which is located on both sides of the armature in the axial direction.

8. The motor according to claim 6, wherein the auxiliary core has a side surface that faces the magnetism guiding portion, and wherein, with respect to the axial direction of the motor, the length of the second surface of the magnetism guiding portion is equal to the sum of a length of a surface of the armature core that faces the magnetism guiding portion and a length of the side surface of the auxiliary core, which is located on both sides of the armature in the axial direction.

9. The motor according to claim 1, further comprising a rotary shaft to which the armature core is fixed, and a commutator fixed to the rotary shaft, the commutator having a circumferentially arranged twenty-four segments, and
wherein eight coils are wound about the armature core, and the permanent magnet has six magnetic poles.
